(19) United States
(12) Patent Application Publication
(10) Pub. No.: US 2004/0018115 A1
(43) Pub. Date: Jan. 29, 2004

(54) Fault tolerant detection regions in microfluidic systems

(75) Inventor: Christoph D. Karp, Pasadena, CA (US)

Correspondence Address: NANOSTREAM, INC., 580 SIERRA MADRE VILLA AVE., PASADENA, CA, 91107-2928, US

(73) Assignee: Nanostream, Inc.

(21) Appl. No.: 10/207,496

(22) Filed: Jul. 29, 2002

(51) Int. Cl. G01N 21/00

(52) U.S. Cl. 422/58; 422/100

(57) ABSTRACT

Microfluidic devices including detection channel geometries that facilitate alignment such detection channels with multiple external sensors are provided. The detection channels include fault tolerant detection channels segments that have a span proportional and parallel to any anticipated positional or dimensional variation of the detection channels with respect to the positions of the multiple external sensors. The detection channels have a substantially constant channel width to minimize pressure-driven channel distortion and dead volumes.

### FIELD OF THE INVENTION

The present invention relates to design and fabrication of microfluidic devices.

### BACKGROUND OF THE INVENTION

There has been a growing interest in the manufacture and use of microfluidic systems for the acquisition of chemical and biological information. In particular, when conducted in microfluidic volumes, complex chemical and biochemical reactions may be carried out using very small volumes of liquid. Among other benefits, microfluidic systems improve the response time of reactions, minimize sample volume, and lower reagent consumption. When volatile or hazardous materials are used or generated, performing reactions in microfluidic volumes also enhances safety and reduces disposal quantities.

When employing microfluidic systems, it may be desirable to provide means for observing and/or analyzing fluids contained within the system, i.e., “on-board detection.” Examples of detection technology include, but are not limited to, optical detectors for performing UV-visible spectroscopy, Raman spectroscopy, fluorescence detection, chemiluminescence or other desirable forms of optical detection. Such detectors typically function by sensing optical emissions from the analyte and/or illuminating the analyte and measuring the resultant reflectance, transmission, and/or emission. In order to perform such optically based detections in microfluidic systems, an optical sensor may be positioned over a detection channel that carries fluid from a reaction chamber, separation channel or similar functional microstructure. If a microfluidic device has more than one detection channel, then multiple sensors may be provided (e.g., in a sensor manifold) to sense one or more fluid properties within each detection channel simultaneously.

However, sensors used in conjunction with microfluidic devices typically have a limited field of view or sensor area, thus any variation in the position or dimensions of the microfluidic device may interfere with the ability of one or more sensors in the manifold to sense its respective detection channel. Furthermore, if sensors having a field-of-view approximately the same width as the detection channel in question are employed, then precise alignment of the channels and the sensors may be difficult.

Many of the materials used to fabricate microfluidic devices may be susceptible to dimensional variation. For instance, the application of heat during the fabrication process may cause certain polymers, such as polypropylene, to contract or shrink. Also, certain fabrication techniques, such as the use of stencils (discussed below), micromachining, molding or etching, may create additional dimensional variation or imprecision. Furthermore, many applications of microfluidic devices propose the use of microfluidic “modules” which may be removed from and replaced in one or more analysis tools. Preferably, the geometry of a sensor manifold associated such tools would be fixed to obviate the need to re-configure the manifold each time a new microfluidic module is introduced. Thus, it may be difficult to consistently and accurately position a microfluidic module within such a system to ensure adequate sensor-to-detection channel communication.

It has been found that the use of registration pins may be used to consistently control dimensional or positional variation in one direction or dimension, so that a device may precisely aligned in that one dimension. However, registration pins may not prevent dimensional or positional variations in the direction or dimension orthogonal to the aligned dimension.

Accordingly, there exists a need for microfluidic devices having multiple detection channels that may be readily aligned with multiple discrete external sensors (such as optical detectors).

### SUMMARY OF THE INVENTION

In one aspect of the present invention, a microfluidic device comprises a plurality of device layers defining a fixed axis, a variable axis, and an alignment tolerance dimension along the variable axis. A detection channel is defined in at least one of the device layers. The detection channel includes a fault tolerant detection segment. The fault tolerant detection segment is oriented orthogonally to the fixed axis and has a span parallel to the variable axis. The span of the fault tolerant detection segment is proportional to the alignment tolerance dimension.

This and other aspects and advantages of the invention will be apparent to the skilled artisan upon review of the following description, drawings and claims.

### BRIEF DESCRIPTION OF THE DRAWINGS

FIG. 1A is a top view of multiple sensors superimposed over a portion of a first microfluidic structure having multiple detection channels. FIG. 1B is a top view of multiple sensors superimposed over a portion of a second microfluidic structure having multiple detection channels. FIG. 1C is a top view of multiple sensors superimposed over a portion of a third microfluidic structure having multiple detection channels, the microfluidic structure according to a preferred embodiment of the present invention.

FIG. 2A is a top view of a single detection channel of the microfluidic structure of FIG. 1B. FIG. 2B is a top view of a single detection channel of the microfluidic structure of FIG. 1C.

FIG. 3A is an exploded perspective view of a portion of a microfluidic device according to the present invention. FIG. 3B is a top view of a portion of the assembled device of FIG. 3A.

### DETAILED DESCRIPTION OF PREFERRED EMBODIMENTS OF THE INVENTION

Definitions

The terms “channel” or “chamber” as used herein are to be interpreted in a broad sense. Thus, they are not intended to be restricted to elongated configurations where the transverse or longitudinal dimension greatly exceeds the diameter or cross-sectional dimension. Rather, such terms are meant to comprise cavities or tunnels of any desired shape or configuration through which liquids may be directed. Such a fluid cavity may, for example, comprise a flow-through cell where fluid is to be continually passed or, alternatively, a chamber for holding a specified, discrete ratio of fluid for a specified ratio of time. “Channels” and “chambers” may be filled or may contain internal structures comprising, for example, valves, filters, and similar or equivalent components and materials.

The term “microfluidic” as used herein is to be understood to refer to structures or devices through which a fluid is capable of being passed or directed, wherein one or more of the dimensions is less than about five hundred microns.

The terms “stencil” or “stencil layer” as used herein refer to a material layer or sheet that is preferably substantially planar, through which one or more variously shaped and oriented channels have been cut or otherwise removed through the entire thickness of the layer, thus permitting substantial fluid movement within the layer (as opposed to simple through-holes for transmitting fluid through one layer to another layer). The outlines of the cut or otherwise removed portions form the lateral boundaries of microstructures that are completed when a stencil is sandwiched between other layers, such as substrates and/or other stencils. Stencil layers can be either substantially rigid or flexible (thus permitting one or more layers to be manipulated so as not to lie in a plane).

Microfluidic Devices Generally

In an especially preferred embodiment, microfluidic devices according to the present invention are constructed using stencil layers or sheets to define channels and/or chambers. As noted previously, a stencil layer is preferably substantially planar and has a channel or chamber cut through the entire thickness of the layer to permit substantial fluid movement within that layer. Various means may be used to define such channels or chambers in stencil layers. For example, a computer-controlled plotter modified to accept a cutting blade may be used to cut various patterns through a material layer. Such a blade may be used either to cut sections to be detached and removed from the stencil layer, or to fashion slits that separate regions in the stencil layer without removing any material. Alternatively, a computer-controlled laser cutter may be used to cut portions through a material layer. While laser cutting may be used to yield precisely dimensioned microstructures, the use of a laser to cut a stencil layer inherently involves the removal of some material. Further examples of methods that may be employed to form stencil layers include conventional stamping or die-cutting technologies, including rotary cutters and other high throughput auto-aligning equipment (sometimes referred to as converters). The above-mentioned methods for cutting through a stencil layer or sheet permits robust devices to be fabricated quickly and inexpensively compared to conventional surface micromachining or material deposition techniques that are conventionally employed to produce microfluidic devices.

After a portion of a stencil layer is cut or removed, the outlines of the cut or otherwise removed portions form the lateral boundaries of microstructures that are completed upon sandwiching a stencil between substrates and/or other stencils. The thickness or height of the microstructures such as channels or chambers can be varied by altering the thickness of the stencil layer, or by using multiple substantially identical stencil layers stacked on top of one another. When assembled in a microfluidic device, the top and bottom surfaces of stencil layers are intended to mate with one or more adjacent layers (such as stencil layers or substrate layers) to form a substantially enclosed device, typically having at least one inlet port and at least one outlet port.

A wide variety of materials may be used to fabricate microfluidic devices having sandwiched stencil layers, including polymeric, metallic, and/or composite materials, to name a few. Various preferred embodiments utilize porous materials including filter materials. Substrates and stencils may be substantially rigid or flexible. Selection of particular materials for a desired application depends on numerous factors including: the types, concentrations, and residence times of substances (e.g., solvents, reactants, and products) present in regions of a device; temperature; pressure; pH; presence or absence of gases; and optical properties. For instance, particularly desirable polymers include polyolefins, more specifically polypropylenes, and vinyl-based polymers.

Various means may be used to seal or bond layers of a device together. For example, adhesives may be used. In one embodiment, one or more layers of a device may be fabricated from single- or double-sided adhesive tape, although other methods of adhering stencil layers may be used. Portions of the tape (of the desired shape and dimensions) can be cut and removed to form channels, chambers, and/or apertures. A tape stencil can then be placed on a supporting substrate with an appropriate cover layer, between layers of tape, or between layers of other materials. In one embodiment, stencil layers can be stacked on each other. In this embodiment, the thickness or height of the channels within a particular stencil layer can be varied by varying the thickness of the stencil layer (e.g., the tape carrier and the adhesive material thereon) or by using multiple substantially identical stencil layers stacked on top of one another. Various types of tape may be used with such an embodiment. Suitable tape carrier materials include but are not limited to polyesters, polycarbonates, polytetrafluoroethlyenes, polypropylenes, and polyimides. Such tapes may have various methods of curing, including curing by pressure, temperature, or chemical or optical interaction. The thickness of these carrier materials and adhesives may be varied.

In another embodiment, device layers may be directly bonded without using adhesives to provide high bond strength (which is especially desirable for high-pressure applications) and eliminate potential compatibility problems between such adhesives and solvents and/or samples. Specific examples of methods for directly bonding layers of non-biaxially-oriented polypropylene to form stencil-based microfluidic structures are disclosed in copending U.S. Provisional Patent Application Serial No. 60/338,286 (filed Dec. 6, 2001) and No. ______ (filed Jul. 2, 2002), which are owned by assignee of the present application and incorporated by reference as if fully set forth herein. In one embodiment, multiple layers of 7.5-mil (188 micron) thickness “Clear Tear Seal” polypropylene (American Profol, Cedar Rapids, Iowa) including at least one stencil layer may be stacked together, placed between glass platens and compressed to apply a pressure of 0.26 psi (1.79 kPa) to the layered stack, and then heated in an industrial oven for a period of approximately five hours at a temperature of 154° C. to yield a permanently bonded microstructure well-suited for use with high-pressure fluidic processes.

Notably, stencil-based fabrication methods enable very rapid fabrication of devices, both for prototyping and for high-volume production. Rapid prototyping is invaluable for trying and optimizing new device designs, since designs may be quickly implemented, tested, and (if necessary) modified and further tested to achieve a desired result. The ability to prototype devices quickly with stencil fabrication methods also permits many different variants of a particular design to be tested and evaluated concurrently.

Further embodiments may be fabricated from various materials using well-known techniques such as embossing, stamping, molding, and soft lithography.

In addition to the use of adhesives and the adhesiveless bonding method discussed above, other techniques may be used to attach one or more of the various layers of microfluidic devices useful with the present invention, as would be recognized by one of ordinary skill in attaching materials. For example, attachment techniques including thermal, chemical, or light-activated bonding steps; mechanical attachment (such as using clamps or screws to apply pressure to the layers); and/or other equivalent coupling methods may be used.

Preferred Embodiments

Microfluidic devices according to the present invention include detection channel geometries that facilitate alignment such detection channels with multiple external sensors, such as may be provided in a sensor manifold of a detection device.

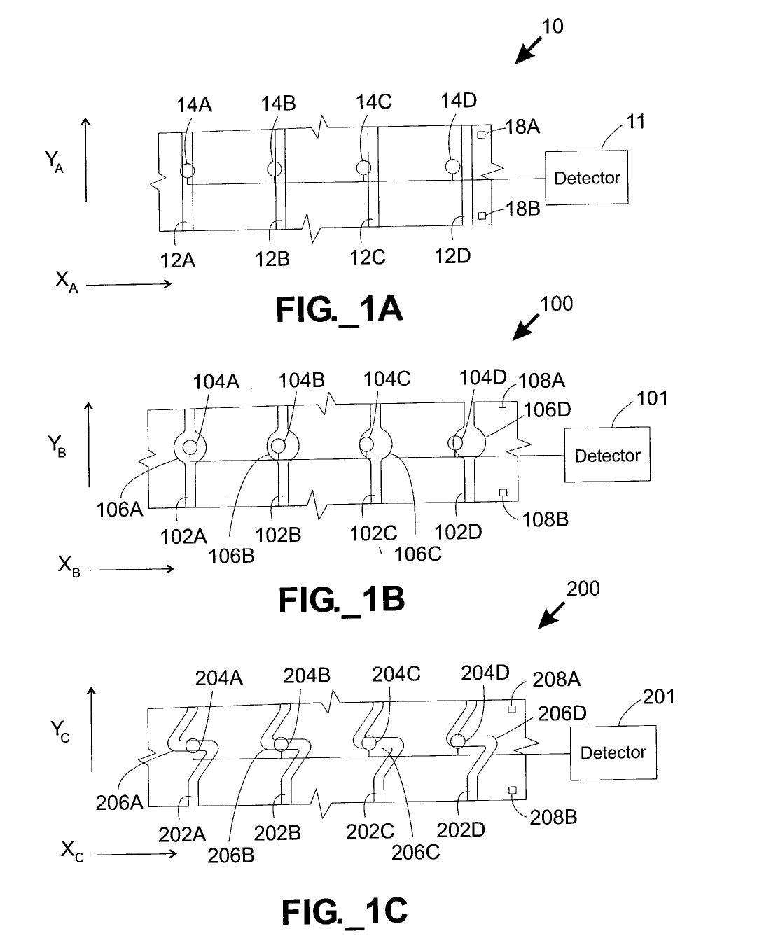

FIGS. 1A-1C illustrate the detection channel regions of three microfluidic devices 10, 100, 200, each with four detection channels 12A-12D, 102A-102D, 202A-202D. The detection channels 12A-12D, 102A-102D, 202A-202D are in fluid communication with other microfluidic structures (not shown) that carry out desirable fluidic functions, such as separation channels, mixers, reaction chambers, etc. The detection channels 12A-12D, 102A-102D, 202A-202D are adapted to be optically transmissive in the appropriate wavelength for the detector 11, 101, 201 to be used. The detector 11, 101, 201 includes sensors 14A-14D, 104A-104D, 204A-204D, which are positioned in a manifold (not shown) to be in sensory communication with the detection channels 12A-12D, 102A-102D, 202A-202D of the devices 10, 100, 200.

Registration pins 18A-18B, 108A-108B, 208A-208B may be used to prevent positional or dimensional variation of the detection channels 12A-12D, 102A-102D, 202A-202D in one direction Y_{A}-Y_{C} (the “fixed axis”). As shown in FIGS. 1A-1C, however, any positional or dimensional variation of the detection channels 12A-12D, 102A-102D, 202A-202D in the horizontal direction X_{A}-X_{C} (the “variable axis”) may result in misalignment of the sensors 14A-14D, 104A-104D, 204A-204D with respect to the detection channels 12A-12D, 102A-102D, 202A-202D.

Referring to FIG. 1A, the detection channels 12A-12D of the microfluidic device 10 are straight channel segments. As a consequence, sensor misalignment as noted above may result in sensors 14A-14D partial or complete loss of signal obtained by one or more the detection channels 12A-12D. for example, the misalignment is sufficient, in the case of sensor 14D, to result in no sensory communication between the sensor 14D and the detection channel 12D.

In contrast, the device 100 illustrated in FIG. 1B includes fault tolerant detection segments 106A-106D. The registration pins 108A-108B prevent any dimensional variation of the detection channels 102A-102D along the fixed axis Y_{B}. Although the same dimensional variation along the variable axis X_{B} as that shown in FIG. 1A is present, the misalignment of the sensors 104B-104D is mitigated by the fault tolerant detection segments 106A-106D. Consequently, even the most misaligned sensor 104D is still in at least partial sensory communication with its respective detection channel 102D.

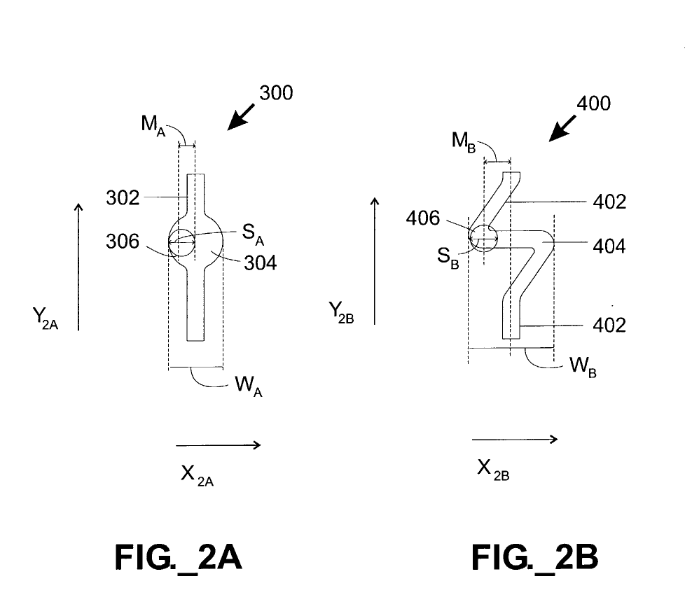

The fault tolerant detection segments 106A-106D are essentially enlarged areas of the detection channels 102A-102D that have a dimension along the variable axis X_{B} that is sufficient to accommodate the anticipated dimensional variation (hereinafter the “alignment tolerance dimension”) along the variable axis X_{B}. For example, referring to FIG. 2A, an analyte detection channel 300 includes channel segments 302 and a fault tolerant detection segment 304. A sensor 306, having a field of view width S_{A}, is positioned over the fault tolerant detection segment 304 and may be misaligned by some alignment tolerance dimension M_{A}. In order to accommodate potential misalignment of the sensor 306, the fault tolerant detection segment 304 should have a span W_{A} sufficient to capture enough of the sensor 306 to allow for adequate data collection. Assuming it is desirable to capture substantially all of the sensor 306, the span W_{A} should preferably equal to about two times the alignment tolerance dimension M_{A} plus the sensor field of view width S_{A}, i.e., W_{A}=(2×M_{A})+S_{A}). If partial capture of the sensor 306 is tolerable, then the span W_{A} may be proportional to the alignment tolerance dimension M_{A} and the sensor width S_{A}, i.e., W_{A}=K×((2×M_{A})+S_{A}) (where K is some proportionality constant that accommodates sensor capture within the desired tolerance). This also assumes the alignment tolerance dimension M_{A} may shift the detection channel 300 in either direction. If the alignment tolerance dimension M_{A} is anticipated in only one direction, then the fault tolerant detection segment 304 may have an expanded span only in the anticipated direction of misalignment.

As shown in FIGS. 1B and 2A, the fault tolerant detection segments 106A-106D are substantially circular. It has been found, however, that enlarged circular channels may present certain limitations. For example, if a microfluidic device with enlarged circular regions is used in high pressure applications, the walls of the chamber formed by the enlarged channel segments 106A-106D, 304 may bulge outward, thus adversely distorting the optical path through the device 100 and potentially inducing error in the data collected by the detector 101. In cases where devices may require active fluid flow through a detection channel during detection, a rapid change in channel width created by an enlarged circular channel can create dead volume in the chamber that may collect air bubbles, which in turn may interfere with data collection. Also, any fluid trapped in such a dead volume may allow fluid from an initial flow through the chamber to contaminate subsequent flow.

Thus, devices utilizing fault tolerant detection segments having substantially constant width, such as the device 200 shown in FIG. 1C, may be desirable. The detection channels 202A-202D of the device 200 include fault tolerant detection segments 206A-206D that are orthogonal to the fixed axis Y_{C} (along which dimensional variation is prevented by the use of registration pins 208A-208B) and parallel to the variable axis X_{C} (along which dimensional variation occurs). Even with the same dimensional variation along the variable axis X_{C} as that shown in FIG. 1A, the misalignment of the sensors 204B-204D is substantially mitigated by the fault tolerant detection segments 206A-206D. Thus, even the most misaligned sensor 204D is still in substantially complete sensory communication with its respective detection channel 202D.

Each fault tolerant detection segment 206A-206D has a dimension along the variable axis X_{B} that is sufficient to accommodate the anticipated dimensional variation along the variable axis X_{B}. For example, referring to FIG. 2B, an analyte detection channel 400 includes channel segments 402 and the fault tolerant detection segment 404. A sensor 406, having a field of view width S_{B}, is positioned over the fault tolerant detection segment 404 and may be misaligned by the alignment tolerance dimension M_{B}. In order to accommodate potential misalignment of the sensor 406, fault tolerant detection segment 404 should have a span W_{B} sufficient to capture enough of the sensor 406 to allow for adequate data collection. Assuming it is desirable to capture substantially all of the sensor 406, the span W_{B} should preferably be equal to about two times the alignment tolerance dimension M_{A} plus the sensor field of view width S_{B}, i.e., W_{B}=(2×M_{B})+S_{B}). If partial capture of the sensor 406 is tolerable, then the span W_{B} may be proportional to the alignment tolerance dimension M_{B} and the sensor field of view width S_{B}, i.e., W_{B}=K×((2×M_{B})+S_{B}) (where K is some proportionality constant that accommodates sensor capture within the desired tolerance). This also assumes the alignment tolerance dimension M_{B} may shift the detection channel 400 in either direction. If the alignment tolerance dimension M_{B} is anticipated in only one direction, then the fault tolerant detection segment 404 may span only in the anticipated direction of misalignment.

One notable feature of the fault tolerant detection segments 206A-206C, 404 illustrated in FIGS. 1C and 2B is the substantially constant channel width over the length of the entire detection channel 202A-202D, 400. In high-pressure applications, the constant width of the analyte detection channel 202A-202D, 400 reduces the likelihood that the walls of the channel 202A-202D, 400 will bulge outward and distort the optical path of a co-located sensor. Also, because the width is substantially constant, there are no sudden or rapid changes in the volume of the channel 202A-202D, 400. Consequently, there is little or no dead volume in the channel 202A-202D, 400 to trap air bubbles (which might interfere with collection of data) or fluid (which might interfere with data or contaminate subsequent fluid flow).

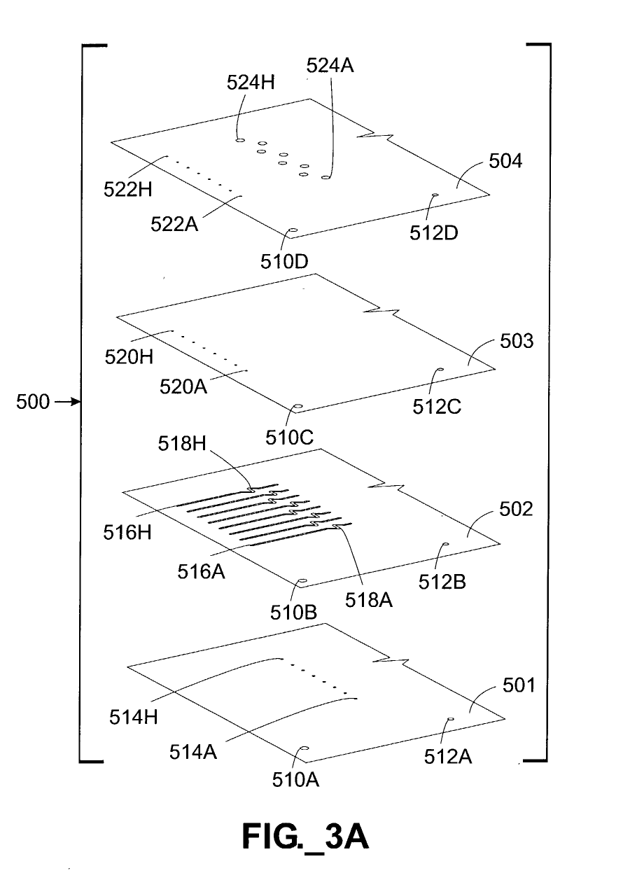

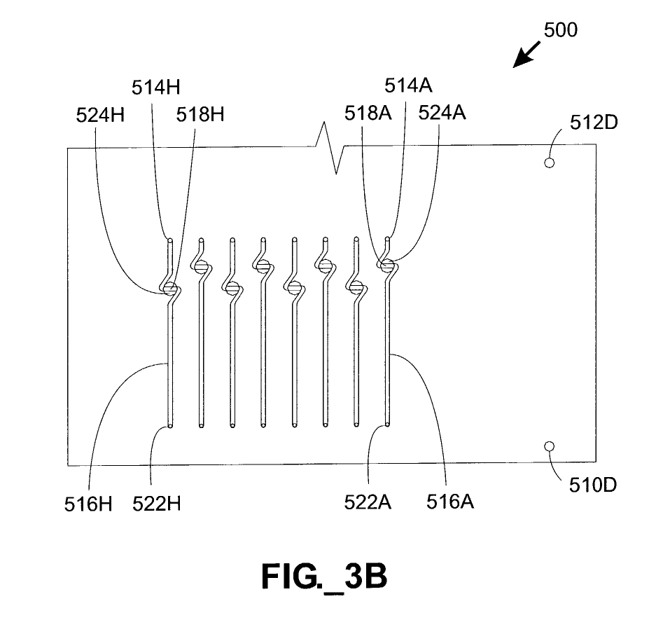

Referring to FIGS. 3A-3B, a multi-layer microfluidic device 500 according to the present invention is fabricated with four device layers 501-504. The first device layer 501 defines two registration apertures 510A, 512A and eight analyte inlet ports 514A-514H (numbering for analyte inlet apertures 514B-514G has been omitted for clarity—this convention is used with respect to all repetitive features of device 500). The second device layer 502, which is a stencil layer, defines two registration apertures 510B, 512B and eight detection channels 516A-516H. Each detection channel 516A-516H includes a fault tolerant detection segment 518A-518H. The third device layer 503 defines two registration apertures 510C, 512C and eight analyte outlet apertures 520A-520H. The fourth device layer 504 defines two registration apertures 510D, 512D, eight analyte outlet ports 522A-522H, and eight windows 524A-524H. Preferably, the third layer 503 is fabricated with a substantially optically transmissive material to facilitate detection of one or more fluid properties of the fluid contents of the detection channels 516A-516H along the fault tolerant detection segments 518A-518H. The device 500 may be assembled by bonding the device layers 501-504 to each other by applying heat and pressure. Alternatively, adhesives (such as self-adhesive device layer materials) may be used.

In operation, the fluids to be analyzed enter the device 500 through the inlet ports 514A-514H and flow through detection channels 516A-516H, including fault tolerant detection segments 518A-518H. The fluids then exit the device 500 through outlet apertures 520A-520H and outlet ports 522A-522H. As discussed above, the geometry of the fault tolerant detection segments 518A-518H compensates for any positional or dimensional variation of the device 500 with respect to a fixed multi-sensor manifold (not shown). Optically transmissive windows 524A-524H may be included to enhance the passage of light through the device 500, thereby improving the sensing performed by the sensors (not shown) interfacing with the device. The optically transmissive windows 524A-524H may merely be apertures cut into device layer 504 or may be windows made glass, quartz or other suitable material affixed within the device layer 504. Additional optically transmissive windows (not shown) also may be provided in device layers 503 and/or 501 if necessary or desirable. The optically transmissive windows 524A-524H may be fashioned in any shape and are preferably sufficiently larger to cover the entirety of the fault tolerant detection segments 518A-518H.

The microfluidic device 500 may be fabricated as a separate unit that is affixed to other microfluidic devices (not shown) in a modular manner. Alternatively, the device 500 may be incorporated as part of a larger, more complex device. Also, it will be readily understood by one skilled in the art that the device 500 may be fabricated using any number of device layers, channel geometries and/or combination of features described herein or otherwise known in the art.

Thus, the present invention provides detection channel geometries that address shrinkage and/or other dimensional variation of polymeric devices. Furthermore, the same channel geometries may be used in microfluidic devices made using more stable manufacturing processes or from more dimensionally stable materials, such as polymers, surface micromachined/etched silicon, metals or other suitable materials known in the art, to allow tolerant interfaces with sensor manifolds. Restated, dimensionally stable devices may benefit from the use of fault tolerant detection channels because of less stringent overall interface to device tolerances.

It is also to be appreciated that the foregoing description of the invention has been presented for purposes of illustration and explanation and is not intended to limit the invention to the precise manner of practice herein. It is to be appreciated therefore, that changes may be made by those skilled in the art without departing from the spirit of the invention and that the scope of the invention should be interpreted with respect to the following claims.

What is claimed is:

1. A microfluidic device comprising:
a plurality of device layers defining a fixed axis, a variable axis, and an alignment tolerance dimension along the variable axis; and
a detection channel defined in at least one of the device layers, the detection channel having a fault tolerant detection segment;
wherein the fault tolerant detection segment is oriented orthogonally to the fixed axis and has a span parallel to the variable axis;
wherein the span of the fault tolerant detection segment is proportional to the alignment tolerance dimension.

2. The microfluidic device of claim 1 wherein the detection channel has a substantially constant cross-sectional area.

3. The microfluidic device of claim 1 wherein any device layer of the plurality of device layers is fabricated with a polymer.

4. The microfluidic device of claim 1 wherein each device layer of the plurality of device layers is an adhesiveless polymer layer.

5. The microfluidic device of claim 4 wherein the polymer layer is a vinyl-based polymer.

6. The microfluidic device of claim 4 wherein the polymer layer is a polyolefin.

7. The microfluidic device of claim 4 wherein the polymer layer is polypropylene.

8. The microfluidic device of claim 1 wherein at least one device layer of the plurality of device layers is a stencil layer.
